(19) United States
(12) Patent Application Publication
(10) Pub. No.: US 2009/0233178 A1
(43) Pub. Date: Sep. 17, 2009

(54) LITHIUM-ION BATTERIES

(76) Inventors: M. Yazid Saidi, Henderson, NV (US); Haitao Huang, Henderson, NV (US)

Correspondence Address: VALENCE TECHNOLOGY, INC., 1889 E. MAULE AVENUE, SUITE A, LAS VEGAS, NV, 89119, US

(21) Appl. No.: 12/047,505

(22) Filed: Mar. 13, 2008

(51) Int. Cl. H01M 10/40

(52) U.S. Cl. 429/326; 429/342

(57) ABSTRACT

The present invention is based on the discovery that certain types of synthetic graphite exhibit superior rate capabilities when used in batteries or cells employing lithium metal phosphate cathodes. Additionally, it has been found that the use of dimethyl carbonate and/or ethyl methyl carbonate in the electrolyte when used in such graphite/lithium methyl phosphate batteries or cells facilitates the discharge reactions on both the cathode and the anode and in particular especially improves the rate capability of the graphite anode.

### FIELD OF THE INVENTION

The present invention relates to electrolytes and graphite anodes for use with lithium metal phosphate cathodes in batteries and electrochemical cells. More particularly the cells or batteries include an anode comprising graphite as the intercalation material, a cathode comprising a lithium metal phosphate and an electrolytic solvent comprising dimethyl carbonate and/or ethyl methyl carbonate.

### BACKGROUND OF THE INVENTION

A battery pack consists of one or more electrochemical cells or batteries, wherein each cell typically includes a positive electrode, a negative electrode, and an electrolyte or other material for facilitating movement of ionic charge carriers between the negative electrode and positive electrode. As the cell is charged, cations migrate from the positive electrode to the electrolyte and, concurrently, from the electrolyte to the negative electrode. During discharge, cations migrate from the negative electrode to the electrolyte and, concurrently, from the electrolyte to the positive electrode.

By way of example and generally speaking, lithium ion batteries are prepared from one or more lithium ion electrochemical cells containing electrochemically active (electroactive) materials. Such cells typically include, at least, a negative electrode, a positive electrode, and an electrolyte for facilitating movement of ionic charge carriers between the negative and positive electrode. As the cell is charged, lithium ions are transferred from the positive electrode to the electrolyte and, concurrently from the electrolyte to the negative electrode. During discharge, the lithium ions are transferred from the negative electrode to the electrolyte and, concurrently from the electrolyte back to the positive electrode. Thus with each charge/discharge cycle the lithium ions are transported between the electrodes. Such lithium ion batteries are called rechargeable lithium ion batteries or rocking chair batteries.

The electrodes of such batteries generally include an electroactive material having a crystal lattice structure or framework from which ions, such as lithium ions, can be extracted and subsequently reinserted and/or from which ions such as lithium ions can be inserted or intercalated and subsequently extracted. Recently a class of transition metal phosphates and mixed metal phosphates have been developed, which have such a crystal lattice structure. These transition metal phosphates are insertion based compounds and allow great flexibility in the design of lithium ion batteries.

A class of such materials is disclosed in U.S. Pat. No. 6,528,033 B1 (Barker et al.). The compounds therein are of the general formula LiₐMI_{b}MII_{c}(PO₄)_{d} wherein MI and MII are the same or different. MI is a metal selected from the group consisting of Fe, Co, Ni, Mn, Cu, V, Sn, Cr and mixtures thereof. MII is optionally present, but when present is a metal selected from the group consisting of Mg, Ca, Zn, Sr, Pb, Cd, Sn, Ba, Be and mixtures thereof. More specific examples of such compounds include compounds wherein MI is iron and more specifically includes LiFe_{b}MII_{c}PO₄ and LiFePO₄ and the like and more specifically LiFe₁₋ₓMgₓPO₄.

Lithium metal phosphates, especially Nasicon related Li₃M(PO₄) (such as Li₃V₂(PO₄)₃) and olivine LiMPO₄, (such as LiFe₁₋ₓMgₓPO₄ or LiFePO₄), possess high rate capability and find use as cathode materials for high power batteries. To build such high power batteries, an anode must be selected that can sustain a high current. Many different synthetic graphite anodes are commercially available, but not all of them meet the requirement of sustaining such high current. The present invention describes the selection of graphite materials which do meet this requirement and further describes the selection of a suitable electrolyte for use with such graphite anodes and lithium metal phosphate cathodes which simultaneously fulfill the requirement of good charge rate capabilities, acceptable life cycle, specific rate and stability.

### SUMMARY OF THE INVENTION

The present invention is based on the discovery that certain types of synthetic graphite exhibit superior rate capabilities when used in batteries or cells employing lithium metal phosphate cathodes. Additionally, it has been found that the use of dimethyl carbonate and/or ethyl methyl carbonate in the electrolyte when used in such graphite/lithium methyl phosphate batteries or cells facilitates the discharge reactions on both the cathode and the anode and in particular especially improves the rate capability of the graphite anode.

### BRIEF DESCRIPTION OF THE DRAWINGS

FIG. 1 charts the rate capabilities of lithium ion cells containing different graphite anodes.

FIG. 2 charts and compares the rate capabilities of lithium ion cells containing different graphite anodes.

FIG. 3 charts the rate capabilities of a specific graphite anode with three different electrolytes.

FIG. 4 shows the voltage profiles of a specific graphite anode in Li cell with different electrolytes.

FIG. 5 shows the capacity retentions @10 C of lithium ion cells with a lithium vanadium phosphate cathode, different graphite anodes and different electrolytes.

FIG. 6 shows the rate capability of a cell with a LiFe_{0.95}Mg_{0.05}PO₄ cathode, a graphite anode and a dimethyl carbonate based electrolyte.

FIG. 7 shows X-ray diffraction peaks for synthetic graphite materials with different ratios of rhombohedral phase to hexagonal phase.

### DETAILED DESCRIPTION OF THE INVENTION

Specific benefits and embodiments of the present invention are apparent from the detailed description set forth herein below. It should be understood, however, that the detailed description and specific examples, while indicating embodiments among those preferred, are intended for purposes of illustration only and are not intended to limit the scope of the invention.

The following is a list of some of the definitions of various terms used herein:

As used herein “battery” refers to a device comprising one or more electrochemical cells for the production of electricity. Each electrochemical cell comprises an anode, a cathode and an electrolyte.

As used herein the terms “anode” and “cathode” refer to the electrodes at which oxidation and reduction occur, respectively, during battery discharge. During charging of the battery, the sites of oxidation and reduction are reversed.

As used herein the terms “nominal formula” or “nominal general formula” refer to the fact that the relative proportion of atomic species may vary slightly on the order of 1 percent to 5 percent, or more typically, 1 percent to 3 percent.

As used herein the words “preferred” and “preferably” refer to embodiments of the invention that afford certain benefits under certain circumstances. Further the recitation of one or more preferred embodiments are not useful and is not intended to exclude other embodiments from the scope of the invention.

Lithium metal phosphates, and in particular Nasicon Li₃V₂PO₄ and olivine LiFe_{0.95}Mg_{0.05}PO₄, possess high rate capabilities and are good candidates as cathode materials for high power lithium ion batteries. To build such lithium ion batteries an anode must be selected that is able to sustain a high current. Many different types of synthetic graphite anode materials are commercially available, but not all of them can meet the criteria specified above. Certain types of synthetic graphite exhibit superior rate capabilities compared to other graphite materials.

The graphite materials that exhibit the superior rate capability are similar to MCMB (meso carbon micro beads) in crystallinity but are not necessarily of spherical morphology. Moreover, the useful graphite materials have a characteristic of a low ratio of rhombohedral phase to hexagonal phase. Commercial graphite such as P25B HG (Nippon Carbon Co., Ltd.) and CMS (Carbonaceous Mesophase Spheres, Shanghai Shanshan Tech.) are good examples of graphite materials that are useful anode materials with lithium metal phosphate cathodes.

It has also been found that certain electrolytes optimize battery performance when the batteries are assembled using such lithium metal phosphate cathodes and graphite anodes. Electrolytes comprising dimethyl carbonate and ethyl methyl carbonate and mixtures thereof facilitate the discharge reaction on both the cathode and anode and in particular improve the rate capability of the graphite anode.

A class of lithium metal phosphates and a solid state method for preparing such lithium metal phosphates is disclosed in U.S. Pat. No. 6,528,033 B1 (Barker et al.). The compounds therein are of the nominal general formula LiₐMI_{b}MII_{c}(PO₄)_{d} wherein MI and MII are the same or different. MI is a metal selected from the group consisting of Fe, Co, Ni, Mn, Cu, V, Sn, Cr and mixtures thereof. MII is optionally present, but when present is a metal selected from the group consisting of Mg, Ca, Zn, Sr, Pb, Cd, Sn, Ba, Be and mixtures thereof. More specific examples of such compounds include compounds wherein MI is iron and more specifically includes materials of the nominal general formulae LiFe_{b}MII_{c}PO₄ and LiFePO₄ and the like and more specifically LiFe₁₋ₓMgₓPO₄. A method for the preparation of an electroactive material of the nominal general formula Li₃V₂(PO₄)₃ is also disclosed therein. As disclosed therein all of these materials find use as cathode active materials. Additional methods of preparing such lithium metal phosphates are disclosed in U.S. Ser. No. 10/850,003; U.S. Ser. No. 11/850,792; U.S. Ser. No. 11/682,339; U.S. Pat. No. 6,913,855; U.S. Pat. No. 6,730,281; U.S. Pat. No. 7,060,206; and U.S. Pat. No. 6,645,452 all hereby incorporated by reference.

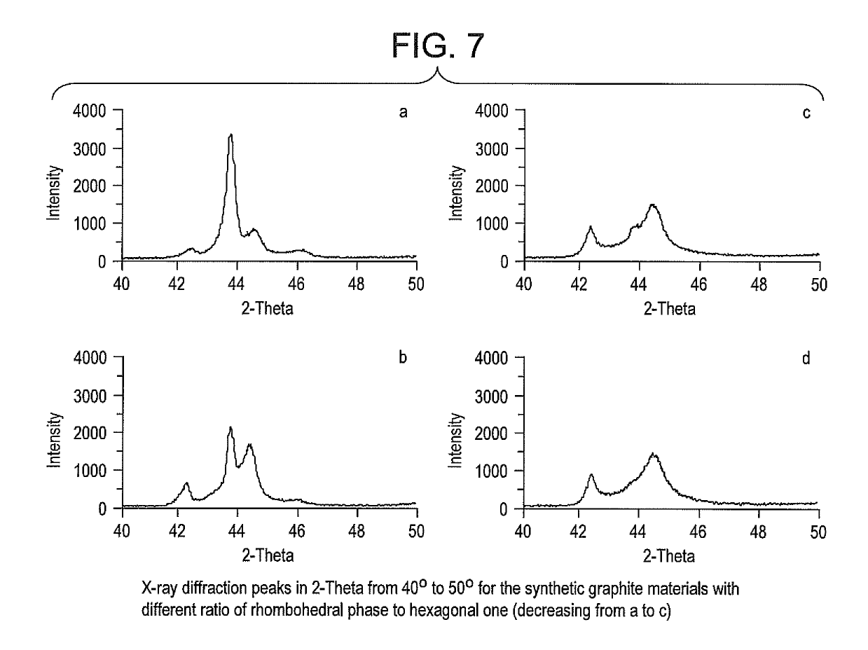

In the present invention the anode (negative electrode) active material comprises synthetic graphite. The graphite chosen exhibits superior rate capability. The graphite is similar to meso carbon microbeads (MCMB, Osaka Gas Co.) in its crystallinity but not necessarily similar in spherical morphology. The preferred graphite is characterized as having a low ratio of rhombohedral phase to hexagonal phase. X-ray diffraction patterns in 2-Theta from 40° to 50° for synthetic graphite materials with different ratio of rhombohedral phase to hexagonal phase are shown in FIG. 7. The ratio depicted in FIG. 7 is decreasing from pattern “a” to pattern “c”. From the diffraction peaks on 43.8° (rhombohedral phase) and 44.4° (hexagonal phase) the ratio of rhombohedral phase to hexagonal phase is calculated based on the peak area ratio. For purposes of the present invention the ratio of rhombohedral phase to hexagonal phase is less than 1 and preferably less than 0.6.

Examples of preferred commercially available graphites include P25B HG and P20B CGR (from Nippon Carbon Co. Ltd.); CMS (carbonaceous mesophase spheres from Shanghai Shanshan Technology); MCMB2528T, MCMB628 and MCMB1028 (Osaka Gas Co.); MCF (mesophase-pitch-based carbon fiber) and the like. All of these graphite materials have a ratio of rhombohedral phase to hexagonal phase of less than 1 and preferably less than 0.6.

While both natural and synthetic graphites may be employed, synthetic graphites that are highly structured, highly crystalline, anisotropic graphites having a nearly perfect layered structure are preferred. Although other anode materials may be used in addition to the graphite, in preferred embodiments, the anode active material consists primarily of graphite.

The graphite based anodes typically include a polymeric binder and optionally an extractable plasticizer suitable for forming a bound porous composite. Suitable polymeric binders include EPDM (ethylene propylene diamine termonomer), PVDF (polyvinylidene diflouride), HFP (hexafluoropropylene), EAA (ethylene acrylic acid copolymer) EVA (ethylene vinyl acetate copolymer), EAA/EVA copolymers and copolymers of PVDF and HFP and the like. The anodes also optionally contain a conductive carbon (e.g. Super P (Timcal), VGCF (Showa Denko), or carbon black). In one preferred embodiment the anode mix ratios comprise from about 70 to about 90 wt % graphite; from about 1 to about 5 wt % conductive carbon and from about 3 to about 10 wt % PVDF. More preferably the anode mix ratios were 90 wt % graphite; 3 wt % conductive carbon and 7 wt % PVDF.

The cathode active materials (positive electrode) comprise lithium metal phosphates. A class of such materials is disclosed in U.S. Pat. No. 6,528,033 B1 (Barker et al.). The compounds therein are of the general formula LiₐMI_{b}MII_{c}(PO₄)_{d} wherein MI and MII are the same or different. MI is a metal selected from the group consisting of Fe, Co, Ni, Mn, Cu, V, Sn, Cr and mixtures thereof. MII is optionally present, but when present is a metal selected from the group consisting of Mg, Ca, Zn, Sr, Pb, Cd, Sn, Ba, Be and mixtures thereof. More specific examples of such compounds include compounds wherein MI is vanadium or iron and more specifically includes Li₃V₂(PO₄)₃, LiFe₁₋ₓMgₓPO₄ and LiFePO₄. U.S. Pat. No. 6,645,452 B1 (Barker et al.) further discloses electroactive vanadium phosphates such as LiVPO₄F, Li₃₋₂ₓNbₓ(PO₄)₃ and LiV_{0.9}Al_{0.1}PO₄F. Such compounds can be prepared according to the processes disclosed in U.S. Pat. Nos. 6,528,033 and 6,645,452, hereby incorporated by reference.

The cathode active materials can optionally be mixed with an electroconductive material including, by way of example, graphite, powdered carbon, conductive polymers, and the like and a polymeric binder. In one embodiment the cathode is prepared from a cathode paste which comprises from about 35 to about 85 wt % cathode active material, from about 1 to about 20 wt % of an electroconductive agent and from 1 to about 20 wt % polymeric binder. The polymeric binders listed above for the anode are examples of polymeric binders useful in forming the cathode.

A non-aqueous electrolyte is provided for transferring ionic charge carriers between the positive electrode and the negative electrode during charge and discharge of the electrochemical cell. The electrolyte includes a non-aqueous solvent and an alkali metal salt dissolved therein capable of forming a stable SEI layer on the negative electrode (most preferably, a lithium salt). In the electrochemical cell's nascent state (namely, before the cell undergoes cycling), the non-aqueous electrolyte contains one or more metal-ion charge carriers.

Suitable solvents include: a non-cyclic carbonates dimethyl carbonate (DMC), ethyl methyl carbonate (EMC) or mixtures thereof. Preferably the solvent comprises a mixture of DMC and EMC. The volume percentage of DMC contained in the electrolyte is at least about 10%, preferably at least about 30% and more preferably about 50%. The volume percentage of EMC optionally contained in the electrolyte is at least 10% and can be present in an amount up to about 50%. When EMC and DMC are both used in the electrolyte solvent they can be present in a volume percentage up to about 80%. Although the electrolytic solvent can include other solvents preferably the electrolyte solvent consists essentially of the DMC or essentially a DMC/EMC mixture.

If desired, one or more additional organic solvents may be included in the electrolyte solvent mixture. Such other organic solvents are preferably selected from the group consisting of ethylene carbonate, diethyl carbonate, dipropyl carbonate, butylenes carbonate and the like, and mixtures thereof. When employed these one or more additional organic solvents preferably comprise about 5% (volume) to about 30% (volume) of the electrolyte solvent mixture

Alkali metal salts, particularly lithium salts, useful in the electrolyte include: LiClO₄; LiBF₄; LiPF₆; LiAlCl₄; LiSbF₆; LiSCN; LiCF₃SO₃; LiCF₃CO₂; Li(CF₃SO₂)₂; LiAsF₆; LiN(CF₃SO2)₂; LiB₁₀Cl₁₀; a lithium lower aliphatic carboxylate; LiCl; LiBr; LiI; a chloroboran of lithium; lithium tetraphenylborate; lithium imides; LiBOB (lithium bis(oxalate)borate) and mixtures thereof. Preferably, the electrolyte contains at least LiPF₆. The electrolyte typically comprises from about 5 to about 25 wt % of the alkali metal salt based on the total weight of the electrolyte; preferably from about 10 to 20 wt %.

Typically for electrochemical testing, composite anodes were fabricated using about 90-wt % active material, about 3-wt % Super P (conductive carbon) and about 7-wt % PVDF (Elf Atochem) binder. The electrolyte comprised a 1M LiPF₆ solution in DMC/EMC (2:1 by weight) while a dried glass fiber filter (Whatman, Grade GF/A) was used as the electrode separator. Li₃V₂(PO₄)₃ was used as the anode active material. High-resolution electrochemical measurements were performed using the Electrochemical Voltage Spectroscopy (EVS) technique. (J. Barker, Electrochim. Acta, 40, 1603 (1995)). EVS is a voltage step method, which provides a high resolution approximation to the open circuit voltage curve for the electrochemical system under investigation. Cycling tests of the hybrid-ion cells were performed using a commercial battery cycler (Maccor Inc., Tulsa, Okla., USA).

The following non-limiting examples illustrate the compositions and methods of the present invention.

### EXAMPLE 1

### Preparation of Graphite Anodes

The graphite anodes were prepared by mixing graphite powder and conductive carbon (e.g. Super P from Timcal, VGCF from Showa Denko) in PVDF/NMP solution. The NMP solvent was removed at 120° C. under vacuum after the mix slurry was coated on Cu (copper) foil. The mix ratios used were, for example, 90 wt % graphite: 3 wt % carbon: and 7 wt % PVDF. The loading of active material was 8-6 mgcm⁻².

### EXAMPLE 2

### Preparation of Lithium Vanadium Phosphate Cathodes

Nasicon vanadium phosphate cathodes [Li₃V₂(PO₄)₃] were prepared in a similar procedure to the graphite anodes as described above. An Al (aluminum) foil was used as the substrate and the mix ratios were varied. For the cathode, the ratios were, for example, 85% Li₃V₂(PO₄)₃:8 wt. % carbon: and 7% PVDF. The loading of active material was 11-9 mgcm⁻².

### EXAMPLE 3

To examine the anode rate capability Li ion cells were constructed by laying a piece of glass fiber as separator between a graphite anode and a Li metal phosphate electrode. The area of the graphite anode was 2.85 cm⁻². The cells were discharged (lithiation) at C/5 to 10 mV and held at this voltage until current drop to 10% of its initial value. The cells were then charged (delithiation) to 2V at different currents so as to measure graphite anode rate capacity.

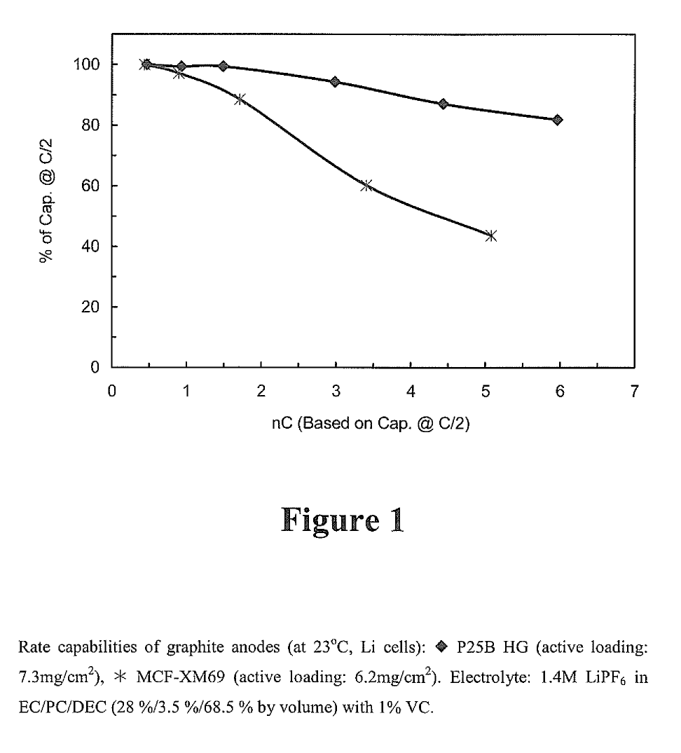

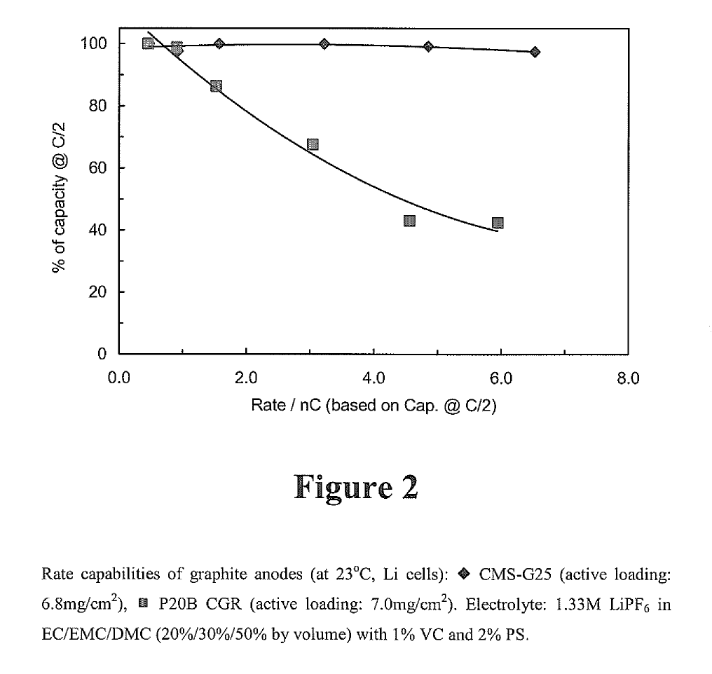

Graphite nature effects rate capability. Different types of graphite have different rate capabilities as shown in FIGS. 1 and 2 in which the graphite anodes were charged (delithiation) at different rates. The electrolyte used for the testing in depicted in FIG. 1 was 1.4M LiPF₆ in EC/PC/DEC (28%/3.5%/68.5% by volume) with 1% VC. The graphite anode made of P25B HG (Nippon Carbon Co. Ltd.) exhibited superior rate capability to the MCF-XM69 anode (mesophase-pitch based carbon fiber.

The electrolyte used for the testing depicted in FIG. 2 was 1.33M LiPF₆ in EC/EMC/DMC (20%/30%/50% by volume) with 1% VC and 2% PS. The graphite anode made of CMS-G25 (carbonaceous mesophase spheres from Shanghai Shanshan Tech.) exhibited superior rate capability to the P20B CGR (Nippon Carbon Co. Ltd) anodes. The former is composed of a very lower proportion of rhombohedral phase to hexagonal phase than the latter.

### EXAMPLE 4

To examine rate capability of the cathode a flat type of Li ion cell was fabricated by using microporous polyolefin separator, e.g. Celgard® 2300 (Celgard LLC). The separator was interleaved between a lithium metal phosphate cathode (e.g. Li₃V₂(PO₄)₃) and a graphite anode. The area of cathode was 15 cm². Using this cell configuration the rate capability of lithium metal phosphate based Li ion battery was tested. To measure rate capacity, the cells were charged at C/2 and discharged at different currents.

### EXAMPLE 5

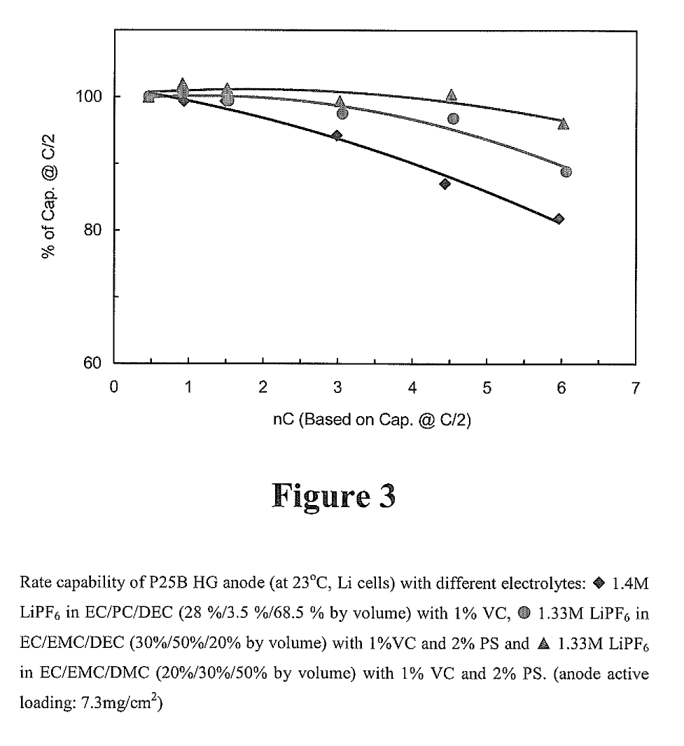

Electrolyte compositions also can affect graphite anode's rate capability as indicated in FIG. 3 in which the same graphite anode (P25B HG) was tested in three different electrolytes with and without DMC or EMC solvents. The electrolyte used for the testing depicted by the square (blue) line was 1.4M LiPF₆ in EC/PC/DEC (28%/3.5%/68.5% by volume) with 1% VC. The electrolyte used for the testing depicted by the by the circle (red) line was 1.33M LiPF₆ in EC/EMC/DEC (30%/50%/20% by volume) with 1% VC and 2% PS. The electrolyte used for the testing depicted by the triangle (green) line was 1.33M LiPF₆ in EC/EMC/DMC (20%/30%/50% by volume) with 1% VC and 2% PS.

The cells employing electrolytes containing EMC and DMC had superior rate capability to the cell employing an electrolyte containing primarily diethyl carbonate (DEC). The cell employing EMC as the primary solvent exhibited better rate capability then the cell employing DEC as the primary solvent. The cell employing DMC as the primary solvent with some EMC as solvent exhibited the best rate capability of the three cells.

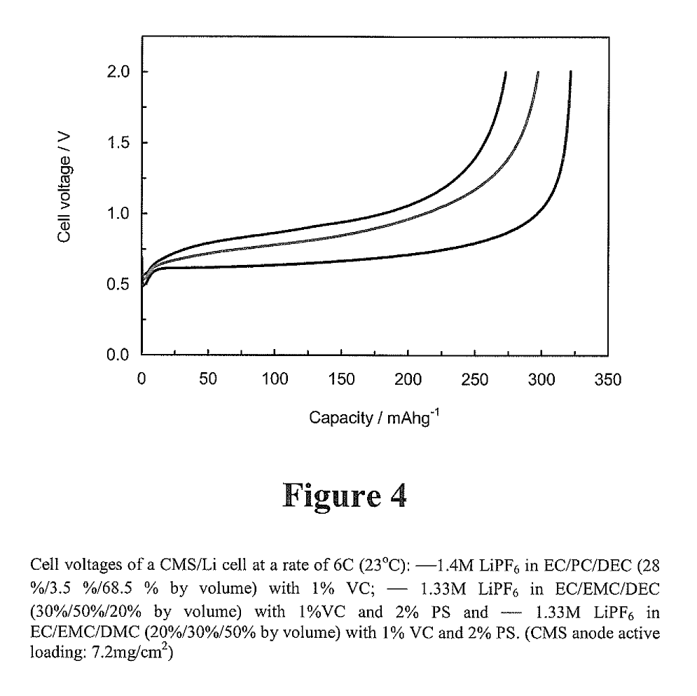

Such an impact is due to the fact that electrolyte composition can affect the polarization of the anode as demonstrated by FIG. 4 in which the voltage profiles of CMS anode in Li cells with different electrolytes are plotted against capacity. Again with this graphite anode the EMC and DMC containing cells exhibited superior capacity then the cell containing DEC as the primary solvent.

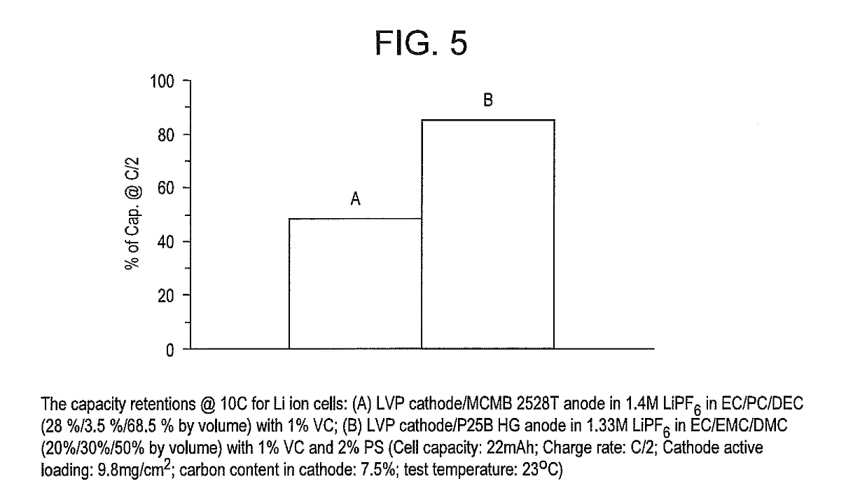

The data in FIG. 5 show that LVP/graphite cells containing a DMC electrolyte solvent positively effects retention. The presence of DMC electrolyte solvent in such graphite/LVP cell solvents is achieves high capacity retention at high rate.

### EXAMPLE 6

### Li₃V₂(PO₄)₃/Graphite Li Ion Battery

Li₃V₂(PO₄)₃ based lithium ion batteries exhibit an excellent rate capacity when a specific graphite anode/electrolyte combination is selected. FIG. 5 shows the comparison of rate capabilities of two such batteries. In the lithium ion battery containing a preferred graphite anode and electrolyte 82% of the C/2 capacity remained when 82% of c/2 capacity remained when being discharged at 10 C even at 23° C.

### EXAMPLE 7

### LiFe_{0.95}Mg_{0.05}PO₄/Graphite Cell

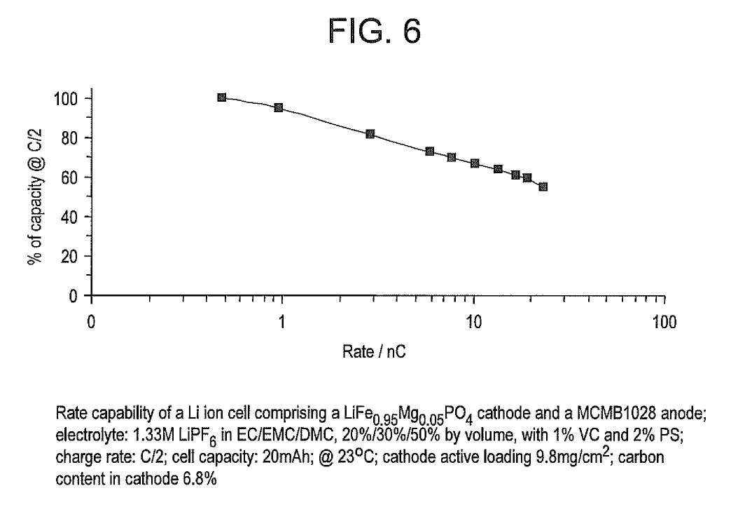

LiFe_{0.95}Mg_{0.05}PO₄ cathodes were prepared in a similar manner as the Li₃V₂(PO₄)₃ cathodes described above. The composition of the cathode is 90.2% active material; 6.8% carbon and 3% PVDF. Such cathode was made into a cell with a MCMB1028 anode. FIG. 6 shows the rate capability testing data of said cell.

What is claimed is:

1. An electrochemical cell comprising:
an anode comprising graphite characterized in that it contains a low ratio of rhombohedral phase to hexagonal phase;
a cathode comprising a lithium metal phosphate; and
an electrolyte comprising dimethyl carbonate, ethyl methyl carbonate or mixtures thereof.

2. An electrochemical cell according to claim 1 wherein the low ratio of rhombohedral phase to hexagonal phase is less than 1.

3. An electrochemical cell according to claim 2 wherein the low ration is less than 0.6.

4. An electrochemical cell according to claim 3 wherein the graphite is similar to meso carbon microbeads.

5. An electrochemical cell according to claim 1 wherein the graphite is selected from the group consisting of P25B HG, carbonaceous mesophase spheres, mesophase pitch based carbon fiber, MCMB628, MCMB1028 and MCMB-2528T.

6. An electrochemical cell according to claim 1 wherein the lithium metal phosphate is of the nominal general formula LiₐMI_{b}MII_{c}(PO₄)_{d}Zₑ wherein MI and MII are the same or different; MI is a metal selected from the group consisting of Fe, Co, Ni, Mn, Cu, V, Sn, Cr and mixtures thereof; MII is optionally present, but when present is a metal selected from the group consisting of Mg, Ca, Zn, Sr, Pb, Cd, Nb Sn, Ba, Be and mixtures thereof; a is greater than 0 and less than or equal to 3; the sum of b plus c is greater than 0 and up to about 2, d is greater than 0 and less than or equal to 3; and e is greater than or equal to 0 and less than or equal to 3.

7. An electrochemical cell according to claim 6 wherein the lithium metal phosphate is of the nominal general formula selected from the group consisting of Li₃V₂(PO₄)₃, LiFe₁₋ₓMgₓPO₄ and LiFePO₄.

8. An electrochemical cell according to claim 1 wherein the electrolyte solvent comprises DMC in an amount greater than about 10% by volume.

9. An electrochemical cell according to claim 8 wherein the electrolyte solvent comprises DMC in an amount greater than or equal to about 30% by volume.

10. An electrochemical cell according to claim 9 wherein the electrolyte solvent comprises DMC in an amount greater than or equal to about 50% by volume.

11. An electrochemical cell according to claim 1 wherein the electrolyte solvent comprises DMC and EMC.

12. An electrochemical cell according to claim 11 wherein the DMC and EMC electrolyte solvents are present in an amount that is less than or equal to about 80% by volume.
